(19) United States
(12) Patent Application Publication
(10) Pub. No.: US 2011/0204698 A1
(43) Pub. Date: Aug. 25, 2011

(54) DUMPER WITH HEATABLE BODY

(75) Inventor: HARALD WESTNER, Memmingen (DE)

(73) Assignee: Liebherr-Hydraulikbagger GmbH, Kirchdorf/Iller (DE)

(21) Appl. No.: 13/032,782

(22) Filed: Feb. 23, 2011

(30) Foreign Application Priority Data
Feb. 23, 2010 (DE) 10 2010 008 916.8

(51) Int. Cl. B60P 1/28; B60H 1/00; F28D 15/00

(52) U.S. Cl. 298/17 R; 165/41; 165/104.19

(57) ABSTRACT

A dumper with a dump body includes at least one heating system for heating and/or warming up the body, wherein the heat transfer medium of the heating circuit is a liquid carrier medium.

### CROSS-REFERENCE TO RELATED APPLICATION AND CLAIM OF PRIORITY

This application claims the benefit of German Patent Application No. 10 2010 008 916.8, filed on Feb. 23, 2010, in the German Patent and Trademark Office, the disclosures of which are incorporated herein in their entirety by reference.

### BACKGROUND

1. Field of the Invention

The present invention relates to a dumper with a dump body and at least one heating system for heating the body, in particular for heating/warming up the floor surface of the body.

2. Description of the Related Art

Dumpers, also referred to as mining trucks, are all-terrain utility vehicles which are suitable for the transport of loose ground parts or loose bulk materials. For this purpose, the utility vehicle includes an inclinable dump body mounted on the vehicle frame for accommodating the goods to be transported.

To improve and optimize the unloading of a cohesive material from the dump body it is known to realize a body heating by using the exhaust gases released by the drive unit. The generated warming of the loading area turns out to be advantageous in particular for loamy goods, frozen goods or generally all goods which contain sticky or freezable substances.

However, the technical progress in the development of the drive units for such dumpers leads to technical difficulties in the realization of an exhaust-gas-heated dump body. In particular units of newer engine generations neither produce enough hot exhaust gas nor are the exhaust gas back pressures delivered sufficient for the exhaust pipe lengths installed in the dump body. This leads to the fact that exhaust-gas heating systems for a dump body of a dumper are unsuitable for future vehicle generations.

### SUMMARY

According to an aspect of the present invention, a dumper includes: a dump body; and at least one heating circuit for heating the dump body, wherein a heat transfer medium of said at least one heating circuit is a liquid carrier medium.

The heat transfer medium may be a mixture of water and glycol or a hydraulic oil.

At least one heating circuit may include at least one central heat generator. At least one heating circuit may be coupled with at least one liquid circuit that cools a drive unit such as a diesel engine of the dumper by a heat exchanger.

The heating circuit may further include a shut-off member capable of being actuated mechanically or by an actuator to shut off said at least one heating circuit.

At least one heating circuit may include at least one supply channel and at least one return channel positioned in a surface of the dump body.

According to an aspect of the present invention, a dumper includes: a drive unit that powers the dumper; a dump body; a cooling circuit that cools the drive unit; a heating circuit that heats the dump body, the heating circuit coupled to the cooling circuit via a heat exchanger, the heating circuit including a heating channel positioned in the dump body to heat the dump body, wherein a heat transfer medium of the heating circuit and the cooling circuit is a liquid carrier medium, and a heat is transferred from the liquid carrier medium of the cooling circuit to the liquid carrier medium of the heating circuit via the heat exchanger.

According to an aspect of the present invention, a dumper having a drive unit powering the dumper includes: a dump body; a first liquid circuit; a second liquid circuit that controls a temperature of the dump body, the second liquid circuit coupled to the first liquid circuit via a heat exchanger to exchange heat, wherein a heat transfer medium of the first liquid circuit and the second liquid circuit is a liquid carrier medium.

The second liquid circuit may cool the dump body down to a certain temperature level.

The first liquid circuit may include an independent heat generator that generates heat and transfers the heat to the second liquid circuit.

The first liquid circuit may be a liquid circuit that controls a temperature of the drive unit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows a schematic diagram of the body heating in accordance with an embodiment of the present invention; and

FIG. 2 shows a perspective representation of the body with integrated heating according to an embodiment of the present invention.

### DETAILED DESCRIPTION

The present invention will now be described more specifically with reference to the following Embodiments. It is to be noted that the following descriptions of preferred Embodiments of this invention are presented herein for purpose of illustration and description only; it is not intended to be exhaustive or to be limited to the precise form disclosed.

According to an embodiment of the present invention, a dumper includes a dump body and at least one heating system for heating (that includes warming up) the dump body. In accordance with an embodiment of the present invention, the heat transfer medium of at least one heating circuit for heating the dump body is a liquid carrier medium.

The heating circuit and/or the lines of the heating system may extend across the body surface to be heated, whereby the liquid carrier medium releases its heat to the dump body surface. Instead of the conventional exhaust-gas heating system for dumpers, a liquid medium is used in accordance with an embodiment of the present invention, in order to warm up and/or heat the dump body, in particular its floor surface, to which the heat of the liquid carrier medium is released.

According to an embodiment of the present invention, the heat transfer medium is a water-glycol mixture. Alternatively, the use of hydraulic oil as heat transfer medium may be used.

Advantageously, at least one central heat generator of the heating circuit is a liquid-cooled drive unit of the dumper. The liquid heat transfer medium of the heating system may be guided through at least one liquid cooling circuit of the drive unit of the dumper and correspondingly is heated by the waste heat of the drive unit.

Alternatively, an independent heat source designed especially for the heating system and/or a central heat generator can be implemented. For cost and efficiency reasons, however, existing heat sources such as the drive unit of the dumper may be used.

According to an embodiment of the present invention, at least one heating circuit of the heating system is coupled to at least one existing liquid circuit of the dumper. For example, at least one heating circuit is coupled with at least one existing cooling circuit of the drive unit of the dumper. The liquid transfer medium in the existing cooling circuit (e.g., liquid circuit of the dumper) is introduced into the heating circuit of the heating system and provides for warming up and/or heating the dump body. What is expedient is the use of the heat transfer medium of the cooling circuit of the liquid-cooled dumper drive unit in the heating circuit of the heating system. To put it simply, an existing liquid circuit is expanded by the heating function of the body, in that the hot heat transfer medium is diverted to the dump body. The temperature and/or the pressure of the heat transfer medium in the lines of the circuit is sufficient to ensure an effective warming up and/or heating of the loading area of the dump body.

In order not to jeopardize the safety of the drive system of the dumper, it is expedient to realize the coupling between at least one liquid circuit/cooling circuit and at least one heating circuit according to the principle of a dual-circuit system. This is effected for example by using a heat exchanger between the two circuits, which provides for a transfer of heat from the liquid circuit into the heating circuit of the heating system. Accordingly, two circuits with their own liquid carrier medium are formed, which are coupled for heat exchange by the heat exchanger. Creating a separate heating circuit ensures that damages to the body do not lead to a failure and/or impairment of the operability of the machine, since the cooling circuit of the driving machine still operates autonomously.

According to an embodiment of the present invention, at least one motor-driven circulating pump is implemented in the heating circuit for delivering the flow volume inside the heating circuit. The drive of the circulating pump may be effected in particular via a hydraulic or electric drive unit.

In order to activate the heating system for the dump body of the dumper only when necessary, at least one shut-off member may be provided, which may be arranged in the heating circuit and/or in the liquid circuit/cooling circuit of the dumper. The actuation of the shut-off member advantageously is effected via a suitable mechanism or corresponding additional actuators. Thus, the heating system can comfortably be actuated via the general control panel of the dumper or optionally directly be activated or deactivated on the shut-off member via the mechanism provided for this purpose.

To achieve a uniform heating of the floor surface and/or of the wall surfaces of the dump body, at least one supply channel and at least one return channel of the heating system is arranged inside the floor surface and/or wall surface of the body. The division of the heating channel into feed and return ensures a uniform circulation of the liquid heat transfer medium through the channels integrated in the body surface.

According to an embodiment of the present invention, machine components may be heatable by the heating system. For example, the warming up/heating of any kind of transport and loading surfaces, working surfaces of mounted working machines or the like is conceivable.

According to an embodiment of the present invention, the heating function of the dumper is reversible, i.e., a cooling effect of the system is achieved, in order to selectively cool the temperature of the body surface down to a certain temperature level.

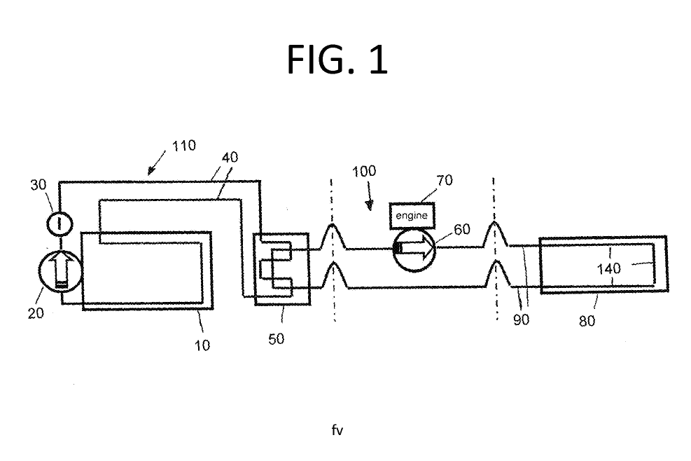

FIG. 1 shows a schematic diagram of the heating system for a dumper in accordance with an embodiment of the present invention. For optimization of the system safety the entire circuit system is configured as a dual-circuit system. The first liquid circuit 110 shows the existing cooling circuit for cooling the drive unit 10 of the dumper. The drive unit 10 of the dumper, for example, includes a diesel engine or some other liquid-cooled drive unit. The delivery of the heat transfer medium through the hose lines 40 is accomplished by the pump 20. The pump can be mounted and/or integrated for example on the side of the motor or be driven by an external device. Via the hose lines 40, which represent a feed and return, the heat transfer medium is delivered to the heat exchanger 50.

Furthermore, an autonomous heating circuit 100 is available, in whose lines 90 a liquid heat transfer medium, for example, a water-glycol mixture or a hydraulic oil, circulates. By the heat exchanger 50 the waste heat generated by the drive unit 10 can be released to the liquid heat transfer medium of the heating circuit 100 despite separately secured recirculation systems 110, 100. The circulation of the medium in the lines 90 is promoted by the circulating pump 60, which is operated by the drive element 70. Suitable configurations of the drive element 70 include, for example, a hydraulic or electric drive motor. The heat obtained via the heat exchanger 50 thus is delivered to the body 80 of the dumper by the circulating pump 60 and ensures a uniform and satisfactory heating of the floor surface of the body 80.

For optional activation or deactivation of the body heating the shut-off member 30 may be installed. If necessary, the shut-off member restricts the inflow of cooling liquid in direction of the heat exchanger 50 or completely prevents the inflow. The heating system accordingly is deactivated and the circulation in the cooling circuit 110 is limited to the drive unit 10. Furthermore, the shut-off member can perform a control function for regulating the heating temperature, for example, with a controller.

The advantageous realization as a dual-circuit system with the autonomous circuits 110, 100 ensures that damages of the heating circuit system 100 to the body do not lead to an impairment of the operability of the dumper, since the cooling circuit 110 of the driving machine remains autonomous. The heating channels 140 of the heating circuit 100 can be integrated in the bottom surface and/or the wall surface of the body 80 or alternatively be attached to the body surface.

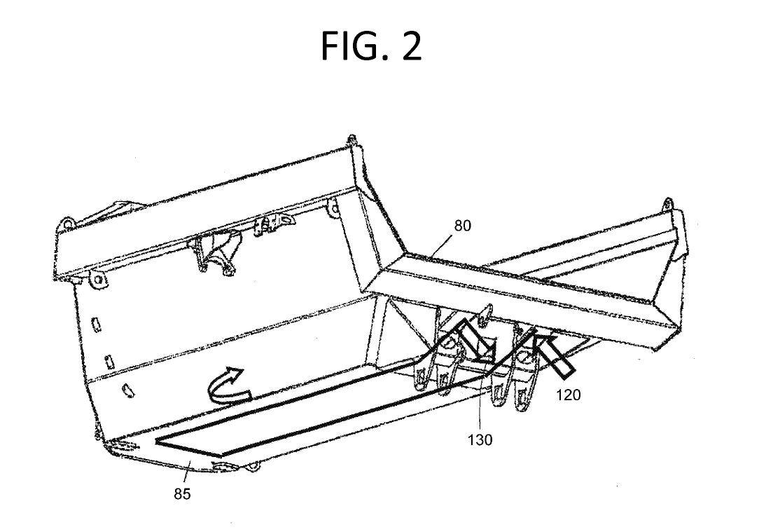

FIG. 2 shows a perspective representation of the body 80 according to an embodiment of the present invention. The heating channel system in the bottom surface 85 of the body 80 includes a supply channel 120 and a return channel 130. To ensure a uniform and efficient heating of the ground surface of the body 80, one heating channel each preferably is arranged at the edge of the ground surface 85 in longitudinal direction, wherein the two heating channels are connected with each other via a transverse channel. In this way, a continuous circulation of the liquid heat transfer medium is achieved in the region of the floor surface of the body 80, wherein the medium is recirculated to the heating system via the separated supply and return channels 120, 130 and/or can be released from the heating system to the body. The direction of circulation of the liquid carrier medium through the heating channels can be chosen as desired.

The embodiment of the present invention may improve and optimize unloading a cohesive material from the dump body 80. For example, this applies in particular to loamy goods, frozen goods or generally speaking to all goods which contain sticky or freezable substances. By warming up the body contact surface a lubricious layer is formed, e.g., a water film, which allows to provide for a safe and approximately 100% neat unloading during the dumping operation.

The configuration of the body heating system in accordance with the embodiment of the present invention may guarantee that the manufacturer is able to continue to equip future dumpers with drive units of the coming engine generations, i.e., generations emitting less exhaust gas, with efficient and effective body heating systems.

While the invention has been described with reference to particular matters, limited embodiments and drawings, it will be understood by those skilled in the art that the invention is not limited to the particular embodiments disclosed since the embodiments are disclosed in the present invention for better understanding of the present invention, but various changes may be made and equivalents may be substituted without departing from the scope of the invention.

Accordingly, it is obvious to those skilled in the art that the invention is not restricted to the embodiments described above, but that claims and all equivalents and modifications of the claims belong to the scope of the present invention.

What is claimed is:

1. A dumper, comprising:
a dump body; and
at least one heating circuit for heating the dump body, wherein a heat transfer medium of said at least one heating circuit is a liquid carrier medium.

2. The dumper according to claim 1, wherein the heat transfer medium is a mixture of water and glycol.

3. The dumper according to claim 1, wherein the heat transfer medium is a hydraulic oil.

4. The dumper according to claim 1, wherein said at least one heating circuit comprises at least one central heat generator.

6. The dumper according to claim 1, wherein said at least one heating circuit is coupled with at least one liquid circuit that cools a drive unit of the dumper.

7. The dumper according to claim 6, wherein the drive unit is a diesel engine.

8. The dumper according to claim 6, wherein said at least one heating circuit is coupled with said at least one liquid circuit by at least one heat exchanger.

9. The dumper according to claim 1, wherein said at least one heating circuit comprises at least one motor-driven circulating pump to circulate the liquid carrier medium.

10. The dumper according to claim 1, wherein the heating circuit comprises a shut-off member capable of being actuated mechanically or by an actuator to shut off said at least one heating circuit.

11. The dumper according to claim 1, wherein said at least one heating circuit comprises at least one supply channel and at least one return channel positioned in a surface of the dump body.

12. A dumper, comprising:
a drive unit that powers the dumper;
a dump body;
a cooling circuit that cools the drive unit;
a heating circuit that heats the dump body, the heating circuit coupled to the cooling circuit via a heat exchanger, the heating circuit comprising a heating channel positioned in the dump body to heat the dump body, wherein a heat transfer medium of the heating circuit and the cooling circuit is a liquid carrier medium, and a heat is transferred from the liquid carrier medium of the cooling circuit to the liquid carrier medium of the heating circuit via the heat exchanger.

13. The dumper according to claim 12, wherein the liquid carrier medium comprises a mixture of water and glycol.

14. The dumper according to claim 12, wherein the liquid carrier medium comprises a hydraulic oil.

15. The dumper according to claim 12, wherein the drive unit is a diesel engine.

16. The dumper according to claim 12, wherein the heating circuit comprises a shut-off member capable of being actuated mechanically or by an actuator to shut off only the heating circuit.

17. A dumper having a drive unit powering the dumper, comprising:
a dump body;
a first liquid circuit;
a second liquid circuit that controls a temperature of the dump body, the second liquid circuit coupled to the first liquid circuit via a heat exchanger to exchange heat, wherein a heat transfer medium of the first liquid circuit and the second liquid circuit is a liquid carrier medium.

18. The dumper of claim 17, wherein the second liquid circuit cools the dump body down to a certain temperature level.

19. The dumper of claim 17, wherein the first liquid circuit comprises an independent heat generator that generates heat and transfers the heat to the second liquid circuit.

20. The dumper of claim 17, wherein the first liquid circuit is a liquid circuit that controls a temperature of the drive unit.
